(19) United States
(12) Patent Application Publication
(10) Pub. No.: US 2026/0175162 A1
(43) Pub. Date: Jun. 25, 2026

(54) PHOSPHONIUM-BASED ANION EXCHANGE POLYMERS FOR MOISTURE SWING DIRECT AIR CAPTURE OF CARBON DIOXIDE

(71) Applicants: Matthew GREEN, Phoenix, AZ (US); Marlene VELAZCO MEDEL, Tempe, AZ (US); Kacie NIIMOTO, Mesa, AZ (US)

(72) Inventors: Matthew GREEN, Phoenix, AZ (US); Marlene VELAZCO MEDEL, Tempe, AZ (US); Kacie NIIMOTO, Mesa, AZ (US)

(73) Assignee: Arizona Board of Regents on Behalf of Arizona State University, Scottsdale, AZ (US)

(21) Appl. No.: 19/431,132

(22) Filed: Dec. 23, 2025

Related U.S. Application Data
(60) Provisional application No. 63/738,395, filed on Dec. 23, 2024.

(51) Int. Cl. B01D 53/14; C08F 8/40; C08F 112/14

(52) U.S. Cl. CPC B01D 53/1493; B01D 53/1475; C08F 8/40; C08F 112/14; B01D 2252/205; B01D 2257/504

(57) ABSTRACT

A phosphonium-based polymeric ionic liquid for moisture-swing direct air capture of carbon dioxide is disclosed. The polymeric ionic liquid comprises a styrene-based backbone and phosphonium groups covalently bonded to the backbone, each substituted with methyl, and bicarbonate counterions associated with the phosphonium groups. The polymeric ionic liquid adsorbs carbon dioxide under cyclic wet-dry conditions and exhibits a capture capacity of at least 500 μmol per gram. Methods of producing the polymeric ionic liquid and methods of capturing carbon dioxide using alternating humidity cycles are also disclosed.

### RELATED APPLICATIONS

This application claims the benefit of U.S. Provisional Patent Application No. 63/738,395, filed Dec. 23, 2024, titled “Exploring Phosphonium-Based Anion Exchange Polymers for Moisture Swing Direct Air Capture of Carbon Dioxide,” the entirety of the disclosure of which is hereby incorporated by this reference.

### TECHNICAL FIELD

This document relates to polymeric ionic liquid (PIL) materials and systems for carbon dioxide capture. More specifically, certain embodiments relate to phosphonium-based anion exchange polymers optimized for moisture-swing direct air capture (DAC) applications.

### BACKGROUND

Direct air capture of carbon dioxide is a critical technology for mitigating climate change. In moisture-swing direct air capture, anion exchange materials can adsorb CO₂ when the surrounding humidity within the environment decreases. This process involves a series of chemical reactions between sorbent counterions and water molecules. A moisture-swing sorbent consists of a polymer backbone, a weak base functional group, and a strong base counterion. Conventional moisture-swing sorbents often rely on ammonium-based polymers, which exhibit limitations in stability and performance under cyclic wet-dry conditions.

### SUMMARY

In some embodiments, a phosphonium-based polymeric ionic liquid for moisture-swing direct air capture of carbon dioxide includes a styrene-based polymer backbone. In some embodiments, a phosphonium group is covalently bonded to the backbone, each substituted with methyl. The styrene-based backbone may include poly(vinylbenzyl) units. The polymer may be crosslinked with divinylbenzene. In some embodiments, the phosphonium groups are quaternary phosphonium groups.

In some embodiments, a phosphonium-based polymeric ionic liquid exhibits a carbon dioxide capture capacity of at least 500 μmol per gram under moisture-swing conditions. In some embodiments, bicarbonate counterions are associated with the phosphonium groups. The polymeric liquid may adsorb carbon dioxide under cyclic wet-dry conditions.

In some embodiments, a method of producing a polymeric sorbent for moisture-swing direct air capture of carbon dioxide includes polymerizing vinylbenzyl monomers to form a styrene-based backbone. The method may include functionalizing the backbone with phosphonium groups each substituted with methyl. The method may also include introducing chloride counterions during functionalization. In some embodiments, the method may include exchanging the chloride counterions with bicarbonate ions. In some embodiments, the polymeric sorbent comprises phosphonium groups with methyl substituents and bicarbonate counterions.

In some embodiments, the polymerization may be suspension polymerization. The functionalization may include reacting vinylbenzyl chloride units with trialkylphosphine. The ion exchange may comprise contacting the polymer with an aqueous bicarbonate solution. The ion exchange may be performed at a temperature between 20° C. and 40° C. In some embodiments, the polymer has an ion-exchange efficiency of at least 90%. The polymer may be dried to a moisture content of less than 5% before use.

In some embodiments, a method of capturing carbon dioxide from ambient air includes providing a polymeric sorbent. The polymetric sorbent may include a styrene-based backbone with phosphonium functional groups covalently bonded to the backbone, each substituted with one or more alkyl groups. The polymetric sorbent may include bicarbonate counterions associated with the phosphonium functional groups. The method may include exposing the polymeric sorbent to ambient air under a first condition of reduced humidity to adsorb carbon dioxide. The method may also include subsequently exposing the polymeric sorbent to a second condition of increased humidity to desorb the carbon dioxide.

According to some embodiments of the methods disclosed herein, the first condition is a relative humidity of less than 20%. In some embodiments, the second condition is a relative humidity of greater than 70%. The polymeric sorbent may capture at least 400 μmol of carbon dioxide per gram during the first condition. In some embodiments, the exposing steps are performed in alternating humidity cycles of 24 hours each. The polymeric sorbent may be regenerated by washing with an aqueous bicarbonate solution after multiple cycles.

The foregoing and other aspects, features, and advantages will be apparent from the DESCRIPTION, DRAWINGS, and CLAIMS.

### BRIEF DESCRIPTION OF THE DRAWINGS

Implementations will hereinafter be described in conjunction with the appended and/or included DRAWINGS.

FIG. 1 illustrates a synthetic scheme for phosphonium-based PIL preparation and ion exchange.

FIG. 2 shows comparative CO₂ uptake performance for phosphonium and ammonium PILs under moisture-swing conditions.

FIG. 3 depicts the adsorption kinetics during the first two hours of the dry phase for different polymer compositions.

### DETAILED DESCRIPTION

The following detailed description provides numerous specific details. Those skilled in the relevant arts understand that embodiments of the disclosure may be practiced without these specific details. The disclosure may also be practiced in different and alternative configurations.

Unless specifically noted, it is intended that the words and phrases in the specification and the claims be given their plain, ordinary, and accustomed meaning to those of ordinary skill in the applicable arts. The singular forms “a,” “an,” and “the” include plural referents unless the context clearly dictates otherwise. Thus, for example, a reference to “a step” includes a reference to one or more of such steps. The words “exemplary,” “example,” “embodiment,” or various forms thereof are used herein to mean serving as an example, instance, or illustration. Any aspect or feature described herein as “exemplary” or as an “example” is not necessarily to be construed as preferred or advantageous over other aspects or designs. The examples are provided solely for purposes of clarity and understanding and do not limit or restrict the disclosure. It is to be appreciated that a myriad of additional or alternate examples of varying scope could have been presented, but have been omitted for purposes of brevity.

Throughout the description and claims of this specification, the words “comprise” and “contain” and variations of the words, for example “comprising” and “comprises”, mean “including but not limited to”, and are not intended to (and do not) exclude other components.

When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

The present disclosure may be understood more readily by reference to the following detailed description taken in connection with the accompanying figures and examples, which form a part of this disclosure. It is to be understood that this disclosure is not limited to the specific materials, devices, methods, applications, conditions, or parameters described and/or shown herein, and that the terminology used herein is for the purpose of describing particular embodiments by way of example only and is not intended to be limiting of the claimed inventions. The term “plurality”, as used herein, means more than one.

Embodiments of the present disclosure relate to phosphonium-based polymeric ionic liquids (PILs) designed for moisture-swing direct air capture (DAC) of carbon dioxide. As used herein, the term “polymeric ionic liquid (PIL)” refers to a polymeric material that exhibits ionic liquid characteristics, such as high ionic conductivity and tunable physicochemical properties. For clarity and consistency throughout this document, this material may be described as “the polymer” or “the polymeric sorbent.” These materials address the limitations of conventional sorbents by combining high CO₂ capture capacity with structural stability under cyclic wet-dry conditions.

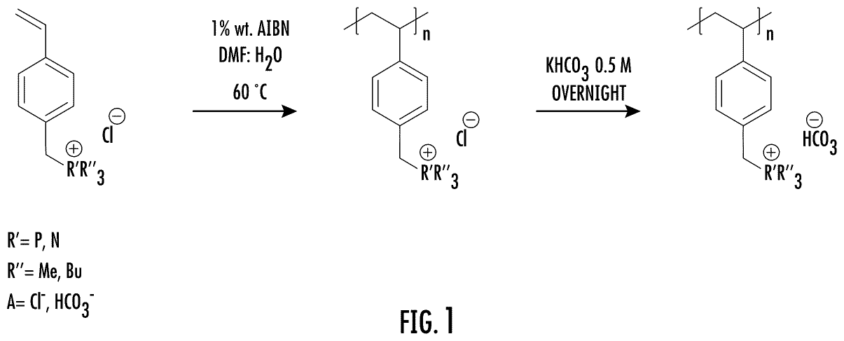

In some embodiments, a PIL comprises a styrene-based backbone functionalized with phosphonium groups. The backbone may include poly(vinylbenzyl) units. These may provide reactive benzylic sites for covalent attachment of phosphonium functionalities. Four polymer variants, denoted as [PVBT-XY], where X represents the alkyl substituent (methyl or butyl) and Y represents the cation type (ammonium or phosphonium), were evaluated. The structure of the polymer is shown in FIG. 1.

FIG. 1 depicts the synthetic route for preparing a PIL according to some embodiments. The preparation of the phosphonium-based PIL involves three principal steps. They will be described below with reference to the example of forming PVBT-MeP, but a similar process applies to making the other three polymer variants with the choice of cation (phosphonium or ammonium) and alkyl substituent (methyl or butyl) adjusted as appropriate.

First, vinylbenzyl monomers are polymerized to construct a styrene-based backbone, as depicted in the left-most structure of FIG. 1. In certain embodiments, this polymerization is performed via suspension polymerization, which enables the formation of uniform polymer beads with controlled morphology. During this step, crosslinking agents such as divinylbenzene may be incorporated to enhance the robustness and mechanical integrity of the polymer network. Crosslinking is particularly advantageous for maintaining porosity and structural stability during repeated wet-dry cycles encountered in direct air capture (DAC) operations. Following backbone formation, the polymer is functionalized by reacting vinylbenzyl chloride units with a trialkylphosphine, resulting in covalently bonded phosphonium groups. This functionalization step introduces the active sites for subsequent ion exchange and CO₂ capture.

Second, methyl substituents—preferred for their electronic neutrality and minimal steric bulk—are incorporated. The electronic neutrality of methyl groups preserves the electrophilic character of the phosphonium center, which promotes strong ion pairing with bicarbonate counterions—for efficient CO₂ adsorption. Additionally, the small size of the methyl group minimizes steric hindrance at the active site, allowing CO₂ molecules to access and interact with the sorbent rapidly. Comparative studies show that methyl-substituted phosphonium polymers outperform those with bulkier substituents (e.g., butyl groups), exhibiting higher CO₂ capture capacity and faster adsorption kinetics. This combination of electronic and steric advantages makes methyl substituents optimal for moisture-swing DAC applications.

Third, to activate the polymer for DAC, these chloride ions are exchanged for bicarbonate ions by immersing the polymer in an aqueous bicarbonate solution-typically potassium bicarbonate (KHCO₃)—at temperatures between 20° C. and 40° C. This temperature range is selected to optimize ion mobility and exchange efficiency while preserving the polymer's structural integrity. The ion-exchange process continues until the majority of chloride ions are replaced by bicarbonate, converting the polymer into its active form for moisture-swing CO₂ capture.

Ion-exchange efficiencies of at least 90% have been demonstrated, as shown in Table 1. Achieving such high efficiency ensures that nearly all active sites within the polymer are occupied by bicarbonate ions, maximizing the material's CO₂ capture capacity. Complete conversion to the bicarbonate form is essential for reliable and reproducible DAC performance, especially under cyclic wet-dry conditions. This robust ion-exchange process also supports the long-term operational viability of the polymeric sorbent, minimizing the risk of incomplete activation or reduced adsorption efficiency in practical applications.

Each polymer was evaluated to determine IECthr (mmol g⁻¹), IECexp (mmol g⁻¹), Ion-Exchange Efficiency (%), and CO₂ Uptake (μmol g⁻¹). The experimental data supporting these findings are summarized in Table 1:

TABLE 1
Ion Exchange Capacity and CO₂ Uptake Performance

| | IECthr | IECexp | Ion-Exchange | CO₂ Uptake |
|---|---|---|---|---|
| Polymer | (mmol g⁻¹) | (mmol g⁻¹) | Efficiency (%) | (μmol g⁻¹) |
| PVBT-MeN | 4.2 | 3.5 ± 0.30 | 83 | 240 ± 140 |
| PVBT-BuN | 2.7 | 2.2 ± 0.23 | 81 | 218 ± 52 |
| PVBT-MeP | 3.9 | 3.8 ± 0.30 | 97 | 512 ± 115 |
| PVBT-BuP | 2.6 | 2.3 ± 0.15 | 88 | 34 ± 6 |

PVBT-MeP exhibited the highest CO₂ capture capacity and fastest adsorption kinetics, attributed to favorable ion pairing, reduced steric hindrance, and lower hydrophilicity. PVBT-MeN demonstrated moderate capacity but high variability (coefficient of variation=58%), while PVBT-BuN provided improved stability with lower capacity. PVBT-BuP showed the lowest performance, likely due to steric hindrance and electronic effects associated with the butyl substituent. These comparative results underscore the critical influence of both cation type and substituent structure on DAC performance.

The phosphonium-based PIL operates via a moisture-swing mechanism, wherein CO₂ adsorption occurs under low-humidity conditions, and desorption occurs under high-humidity conditions. During the dry phase, typically at relative humidity below 20%, the bicarbonate counterions react with CO₂ to form carbonate species, enabling capture from ambient air. In the subsequent wet phase, at relative humidity above 70%, the carbonate species revert to bicarbonate, releasing CO₂. This reversible process is central to the DAC functionality of the polymer. Performance testing under cyclic wet-dry conditions demonstrated that the methyl-substituted phosphonium polymer (PVBT-MeP) achieved a CO₂ capture capacity of approximately 510 μmol per gram.

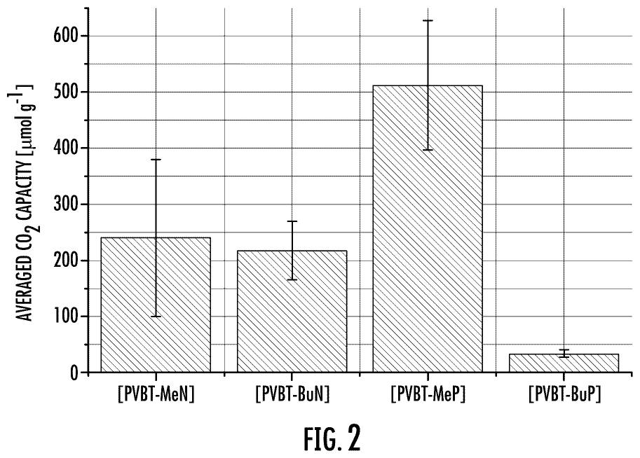

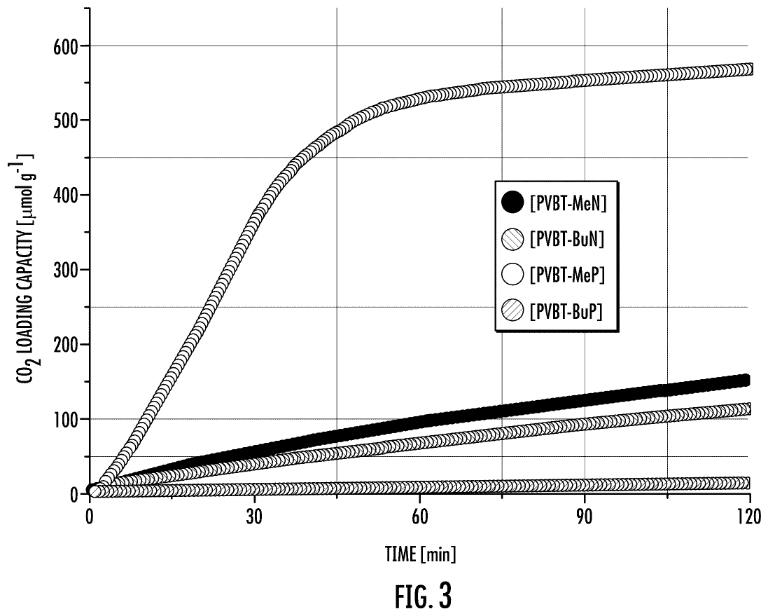

FIG. 2 presents the average CO₂ uptake measured over three 48-hour cycles, highlighting the performance of PVBT-MeP compared to ammonium analogs and phosphonium polymers with bulkier substituents. FIG. 3 illustrates adsorption kinetics during the first two hours of the dry phase, where PVBT-MeP rapidly captured over 500 μmol g⁻¹ of CO₂, underscoring its efficiency.

The stability of these polymers was assessed under five wet-dry cycles and during extended exposure to oxygen. PVBT-MeP exhibited slight oxidative degradation, forming phosphine oxide species detectable by ³¹P NMR spectroscopy, whereas PVBT-BuP degraded more rapidly under identical conditions. In contrast, ammonium-based polymers, particularly PVBT-BuN, maintained structural integrity with no detectable degradation products. Additional experiments in 0.5 M KHCO₃ solution revealed no degradation for any polymer, suggesting that oxidative pathways are driven by dynamic acid-base reactions during moisture-swing cycling rather than by bicarbonate itself. Regeneration of the polymer after multiple cycles may be achieved by washing with an aqueous bicarbonate solution, restoring ion-exchange capacity and maintaining DAC performance.

While slight oxidative degradation was observed in phosphonium-based polymers after extended cycling, the methyl-substituted variant demonstrated relatively greater stability compared to its butyl-substituted counterpart. NMR analysis revealed that degradation primarily occurs via oxidation of phosphorus centers, forming phosphine oxide species. Importantly, no degradation was detected when the polymer was stored in aqueous bicarbonate solution, suggesting that oxidative pathways are driven by dynamic acid-base reactions during moisture-swing cycling rather than by bicarbonate itself. Regeneration of the polymer after multiple cycles may be achieved by washing with an aqueous bicarbonate solution, restoring ion-exchange capacity and maintaining DAC performance.

The phosphonium-based PILs disclosed herein offer several advantages over ammonium-based counterparts. The lower electronegativity and larger atomic radius of phosphorus relative to nitrogen promote stronger ion pairing with bicarbonate, enhancing CO₂ capture capacity. Additionally, methyl substituents reduce steric hindrance and mitigate Hofmann elimination, contributing to improved stability. These structural and electronic features collectively enable high-performance DAC under ambient conditions, addressing critical challenges in carbon capture technology.

Electronic and steric effects may influence performance. Phosphonium cations exhibit lower electronegativity and larger atomic radius compared to ammonium, promoting stronger ion pairing with bicarbonate and reducing water retention during the wet-to-dry transition. This hydrophobic character facilitates efficient water release, critical for the moisture-swing mechanism. Methyl substituents enhance performance by minimizing steric hindrance and preserving structural integrity, while butyl substituents introduce steric bulk and electron-donating effects that weaken ion pairing and reduce CO₂ uptake. The Hammett parameter (σ) analysis supports these observations, indicating that methyl groups maintain electronic neutrality, whereas butyl groups diminish electrophilicity at the cationic center. The absence of β-hydrogen atoms in methyl-substituted phosphonium polymers mitigates Hofmann elimination, contributing to stability during cycling.

Degradation pathways were elucidated through NMR analysis. For phosphonium polymers, oxidative degradation occurs via phosphorus oxidation, forming phosphine oxide peaks at approximately 61.28 ppm in ³¹P NMR spectra. No trialkyl phosphine peaks were detected, confirming oxidation as the primary mechanism. In contrast, ammonium polymers exhibited different degradation behavior, with methyl-substituted variants showing susceptibility to oxidative attack, while butyl-substituted analogs remained stable due to steric shielding. These findings emphasize the interplay between electronic structure, steric effects, and environmental conditions in determining polymer durability.

More specifically, this disclosure, its aspects and embodiments, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

Many additional implementations are possible. Further implementations are within the CLAIMS.

It will be understood that implementations of the preceding disclosure include but are not limited to the specific components disclosed herein, as virtually any components consistent with the intended operation may be utilized. Accordingly, for example, it should be understood that, while the drawings and accompanying text show and describe particular implementations, any such implementation may comprise any shape, size, style, type, model, version, class, grade, measurement, concentration, material, weight, quantity, and/or the like consistent with the intended operation.

The concepts disclosed herein are not limited to the specific embodiments shown herein. For example, it is specifically contemplated that the components included in particular embodiments may be formed of any of many different types of materials or combinations that can readily be formed into shaped objects and that are consistent with the intended operation of the disclosure. For example, the components may be formed of: rubbers (synthetic and/or natural) and/or other like materials; glasses (such as fiberglass), carbon-fiber, aramid-fiber, any combination therefore, and/or other like materials; elastomers and/or other like materials; polymers such as thermoplastics (such as ABS, fluoropolymers, polyacetal, polyamide, polycarbonate, polyethylene, polysulfone, and/or the like, thermosets (such as epoxy, phenolic resin, polyimide, polyurethane, and/or the like), and/or other like materials; plastics and/or other like materials; composites and/or other like materials; metals, such as zinc, magnesium, titanium, copper, iron, steel, carbon steel, alloy steel, tool steel, stainless steel, spring steel, aluminum, and/or other like materials; and/or any combination of the foregoing.

Furthermore, embodiments of the present disclosure may be manufactured separately and then assembled together, or any or all of the components may be manufactured simultaneously and integrally joined with one another. Manufacture of these components separately or simultaneously, as understood by those of ordinary skill in the art, may involve 3-D printing, extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled or removably coupled with one another in any manner, such as with adhesive, a weld, a fastener, any combination thereof, and/or the like for example, depending on, among other considerations, the particular material(s) forming the components.

In places where the description above refers to particular implementations, it should be readily apparent that a number of modifications may be made without departing from the spirit thereof and that these implementations may be applied to other implementations disclosed or undisclosed. The presently disclosed are, therefore, to be considered in all respects as illustrative and not restrictive.

What is claimed is:

1. A phosphonium-based polymeric ionic liquid (PIL) for moisture-swing direct air capture of carbon dioxide, comprising:
a styrene-based polymer backbone; and
phosphonium groups covalently bonded to the backbone, each substituted with methyl.

2. The PIL of claim 1, wherein the styrene-based backbone comprises poly(vinylbenzyl) units.

3. The PIL of claim 1, wherein the polymer backbone is crosslinked with divinylbenzene.

4. The PIL of claim 1, wherein the phosphonium groups are quaternary phosphonium groups.

5. The PIL of claim 1, wherein the PIL exhibits a carbon dioxide capture capacity of at least 500 μmol per gram under moisture-swing conditions.

6. The PIL of claim 1, bicarbonate counterions associated with the phosphonium groups.

7. The PIL of claim 1, wherein the PIL adsorbs carbon dioxide under cyclic wet-dry conditions.

8. A method of producing a polymeric ionic liquid for moisture-swing direct air capture of carbon dioxide, the method comprising by:
polymerizing vinylbenzyl monomers to form a styrene-based backbone;
functionalizing the backbone with phosphonium groups each substituted with methyl;
introducing chloride counterions during functionalization; and
exchanging the chloride counterions with bicarbonate ions;
wherein the polymeric ionic liquid comprises phosphonium groups with methyl substituents and bicarbonate counterions.

9. The method of claim 8, wherein the polymerization comprises suspension polymerization.

10. The method of claim 8, wherein the functionalization comprises reacting vinylbenzyl chloride units with a trialkylphosphine.

11. The method of claim 8, wherein the ion exchange comprises contacting the polymer with an aqueous bicarbonate solution.

12. The method of claim 8, wherein the ion exchange is performed at a temperature between 20° C. and 40° C.

13. The method of claim 8, wherein the polymeric ionic liquid has an ion-exchange efficiency of at least 90%.

14. The polymeric sorbent of claim 8, wherein the polymeric ionic liquid is dried to a moisture content of less than 5% before use.

15. A method of capturing carbon dioxide from ambient air, comprising:
providing a polymeric ionic liquid comprising:
a styrene-based backbone;
phosphonium functional groups covalently bonded to the backbone, each substituted with one or more alkyl groups; and
bicarbonate counterions associated with the phosphonium functional groups;
exposing the polymeric ionic liquid to ambient air under a first condition of reduced humidity to adsorb carbon dioxide; and
subsequently exposing the polymeric ionic liquid to a second condition of increased humidity to desorb the carbon dioxide.

16. The method of claim 15, wherein the first condition comprises a relative humidity of less than 20%.

17. The method of claim 15, wherein the second condition comprises a relative humidity of greater than 70%.

18. The method of claim 15, wherein the polymeric ionic liquid captures at least 400 μmol of carbon dioxide per gram during the first condition.

19. The method of claim 15, wherein the exposing steps are performed in alternating humidity cycles of 24 hours each.

20. The method of claim 15, wherein the polymeric ionic liquid is regenerated by washing with an aqueous bicarbonate solution after multiple cycles.
